(19) United States
(12) Patent Application Publication
(10) Pub. No.: US 2023/0031129 A1
(43) Pub. Date: Feb. 2, 2023

(54) AN INTELLIGENT VEHICLE SEAT MONITORING AND ALERTING SYSTEM

(71) Applicant: Abdallah SHVIKI, Tel Aviv-Yafo (IL)

(72) Inventor: Yevgeny KONSTANTINOVSKY, Ashdod (IL)

(21) Appl. No.: 17/792,750

(22) PCT Filed: Jan. 7, 2021
(86) PCT No.: PCT/IL2021/050026

§ 371 Date: Jul. 14, 2022

(30) Foreign Application Priority Data
Jan. 15, 2020 (IL) 272059

(51) Int. Cl. G08B 21/02

(52) U.S. Cl. CPC G08B 21/0208; G08B 21/023; G08B 21/0291

(57) ABSTRACT

An intelligent vehicle seat monitoring and alerting system, comprising: an enclosure, a camera being adapted to detect motion and to recognize faces in conjunction with suitable processing hardware and software, a distance detection sensor, adapted to measure a distance to a target object and to detect the presence of objects at different distance than an initially taught reference distance, for detecting the presence of an object in a target vehicle seat, by utilizing the camera and the distance detection sensor, a controller for controlling the camera and the TOF sensor, to alert a driver when detecting a child being left in a parking vehicle's seat, a communication module capable of communicating wirelessly with one or more remote stations, a rechargeable power storage of suitable capacity for providing sufficient electric power for the operation of the system, a charging port utilized as a power supply connection inlet being connected to a vehicular power supply, and a charging management module being adapted to control the charging of the rechargeable power storage through the charging port, and to detect a vehicle's engine shut-off resulting with the power supply to the charging port being shut-off.

### FIELD OF THE INVENTION

The present invention is in the field of child safety systems. More particularly, the invention relates to an intelligent vehicle seat monitoring and alerting system which utilizes integrated presence and motion sensing and image processing capabilities for monitoring and alerting when a child is inadvertently left in a vehicle seat. The present invention may be further applied for presence detection and alerting in the application of different fields.

### BACKGROUND OF THE INVENTION

The field of alerting devices intended to prevent the leaving of a child in a vehicle offers a plurality of devices. Many devices are reminder items being attached to a keychain which is disadvantageous, since a reminder item which is routinely viewable, may lose its reminding effectivity. Other devices comprise various sensors embedded into a safety seat, such as pressure sensors detecting the weight of a child, or electro-mechanical devices which connects between the two elements of the seatbelt buckle. Some devices replace the original seatbelt buckle for detecting a secured seatbelt when the adult leaves the vehicle away.

Unfortunately, the above mentioned alert devices depend on initiated user operations (e.g., detaching a reminding item from a keychain, buckling together elements of the alerting device) further to the placing and buckling of the child in the seat. Furthermore, the above mentioned alert devices require complex adding/replacing electro-mechanical components in the vehicle, or the safety seat.

Furthermore, existing alerting devices offered by the market are prone to false alerts such as pressure sensitive systems that can initiate an alert in case an object (e.g., a handbag or a backpack) weighing near to as a young baby, or in distance triggered systems (e.g., having a first element attached to the safety seat and a second element carried by the driver, where a predefined distance between the first and second elements triggers an alert) with consumed battery resulting with signal loss at a near distance.

It is therefore an object of the present invention to provide an intelligent vehicle seat monitoring and alerting system, which alerts one or more users when a child is inadvertently left in a vehicle seat.

It is another object of the present invention to provide an intelligent vehicle seat monitoring and alerting system, which is simple to install and is not dependent on the vehicle's electromechanical systems.

It is yet another object of the present invention to provide an intelligent vehicle seat monitoring and alerting system, which consumes low battery power by utilizing an improved detection mode of operation.

Other objects and advantages of the invention will become apparent as the description proceeds.

### SUMMARY OF THE INVENTION

An intelligent vehicle seat monitoring and alerting system, comprising: an enclosure, a camera being adapted to detect motion and to recognize faces when being utilized in conjunction with suitable processing hardware and software, at least one distance detection sensor, such as TOF sensors, being adapted to measure a distance to a target object, and to detect the presence of objects at different distance than an initially taught reference distance, thereby being capable of detecting the presence of an object in a target vehicle seat, by utilizing the camera and the at least one distance detection sensor, a controller being configured to control the camera and the at least one TOF sensor, thereby to alert a driver when detecting a child being left in a parking vehicle's seat, a communication module capable of communicating wirelessly with one or more remote stations (e.g., a GPRS module which enables communication with remote phones and an internet connection), a rechargeable power storage of suitable capacity for providing sufficient electric power for the operation of the system, a charging port being utilized as a power supply connection inlet being connected to a vehicular power supply, and a charging management module being adapted to control the charging of the rechargeable power storage through the charging port, and to detect a vehicle's engine shut-off resulting with the power supply to the charging port being shut-off.

According to an embodiment of the present invention, the system is provided with attachment means of the enclosure to a vehicles' ceiling, and according to another embodiment of the present invention, the system is provided with attachment means of the enclosure to a vehicles' front windshield.

According to a preferred embodiment of the present invention, the power storage is a rechargeable battery, and the system further comprises a capacity level module being adapted to indicate the stored power level of the rechargeable power storage and to alert in case of power faults.

According to some embodiments of the present invention, the system is provided with additional sensors being selected from the group consisting of: temperature sensors, infrared sensors, CO level sensors, CO2 level sensors, NOx level sensors, GPS receiver, sound detection sensors, or any combination thereof.

According to a preferred embodiment of the present invention, the charging port is a USB port, being utilized as a data connection for system configuration and software updates.

According to an embodiment of the present invention, the system further comprising 2-way communication sound and/or video means for communicating with a child left in the car.

### BRIEF DESCRIPTION OF THE DRAWINGS

FIG. 1 shows a perspective view of the proposed vehicle seat monitoring and alerting system, according to an embodiment of the present invention;

FIG. 2 schematically illustrates an exemplary installation of the proposed system, according to an embodiment of the present invention; and

FIG. 3 schematically illustrates an exemplary configuration of the proposed system, according to an embodiment of the present invention.

### DETAILED DESCRIPTION OF PREFERRED EMBODIMENTS

The present invention relates to an intelligent vehicle seat monitoring and alerting system, which utilizes integrated presence and motion detection and Image capturing and processing capabilities for monitoring one or more desirable locations in a vehicle for detecting and alerting when a child is left in a parking vehicle, without requiring any additional device to be carried by the driver, other than his regular smartphone running a suitable application. Furthermore, the proposed system utilizes machine learning capability and closed-loop feedback to continuously update the child presence characteristic and detection threshold.

Reference will now be made to several embodiments of the present invention, examples of which are illustrated in the accompanying figures for purposes of illustration only. One skilled in the art will readily recognize from the following description that alternative embodiments of the comprising elements herein may be employed without departing from the principles of the claimed invention.

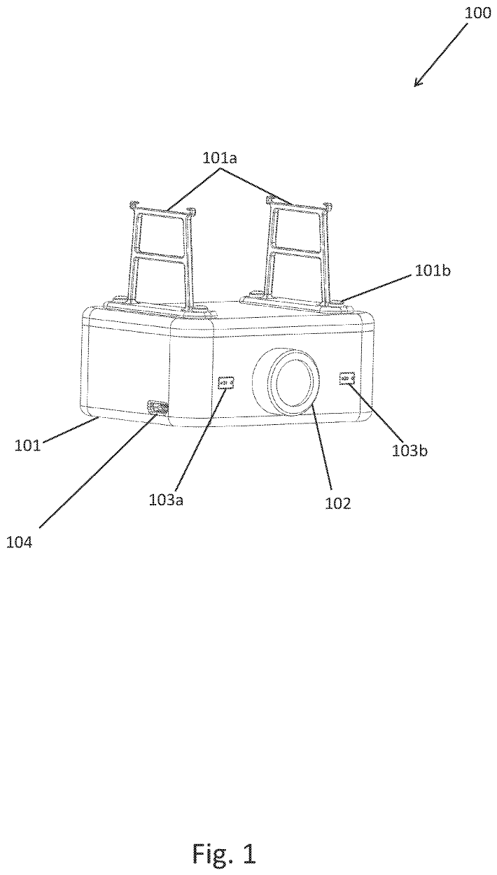

FIG. 1 shows a perspective view of the proposed vehicle seat monitoring and alerting system, according to an embodiment of the present invention, in which system 100 comprising an enclosure 101, vehicle ceiling attachment brackets 101a being attached to enclosure 101 with bolts 101b, a camera 102 which is adapted to detect motion and to recognize faces when utilized in conjunction with suitable processing hardware and software, first and second distance detection sensors such as Time Of Flight sensors (herein referred to as “TOF”) 103a and 103b, and a charging port such as a Universal Serial Bus (USB) port 104, which may be utilized a power supply inlet and optionally as a reading/writing data port for system configuration and software updates. Each distance detection sensor is adapted to measure a distance to a target object, and to detect the presence of objects at a different distance than an initially taught reference distance, so as to detect the presence of an object in a target vehicle seat, by utilizing the camera.

Of course, multiple attachment means and coupling means can be employed for positioning system 100 at the desired location such as magnetic means, suction means and other means that can be suitably selected by a person skilled in the art.

Camera 102 is adapted to capture video and stills images, and when utilized in conjunction with suitable processing and control hardware and software, camera 102 may also detect motion and recognize faces.

TOF sensors 103a and 103b are capable of detecting the distance to a target object in accordance with the required time required for a transmitted signal to be reflected and received by the sensors, and can be taught with an initial referenced distance value “Xo” (e.g., during new installation or following adding/removing/changing the position of a safety seat) and then be configured to indicate whenever a different value than Xo is detected. Hence sensors 103a and 103b are capable of identifying, for example, an empty/occupied safety seat.

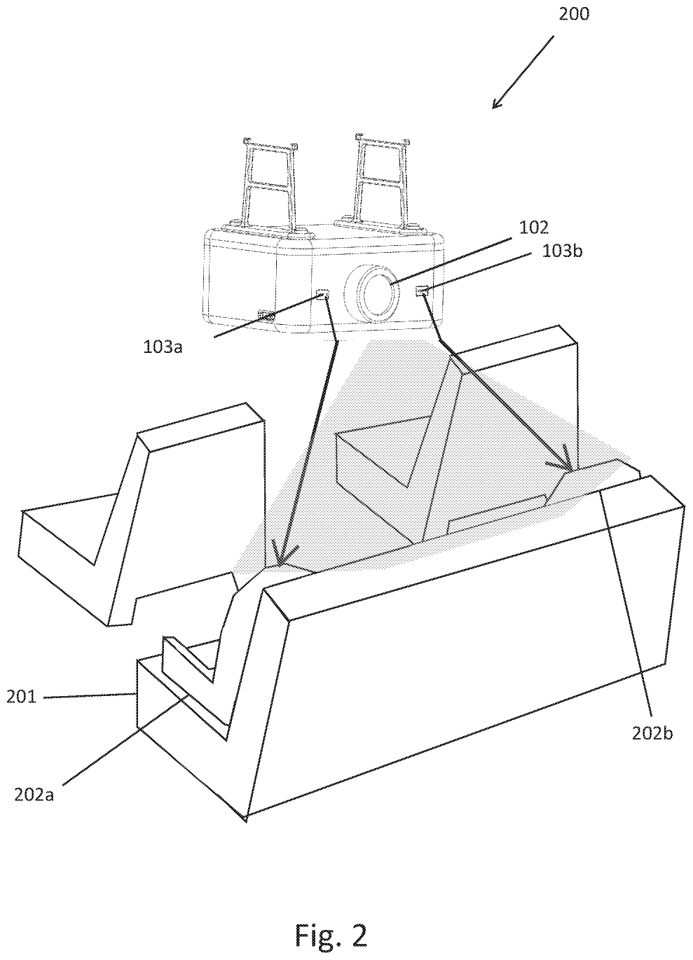

FIG. 2 schematically illustrates an exemplary installation of the proposed system, according to an embodiment of the present invention, in which system 200 is installed and configured to monitor the back seat 201 of a vehicle, being anchored to the vehicle ceiling and facing back seat 201, where camera 102 is having a suitable lens to cover the entire width of back seat 201 while TOF sensors 103a and 103b are being aimed correspondingly to safety seats 202a and 202b, in which children are being routinely seated, thereby capable of indicating for the presence of a child in one of the safety seats 202a and 202b. The focusing of system 200 in monitoring specific targets such as seats 202a and 202b (i.e., by TOF sensors) may prevent false alarm related to adults desirably seating in a parking vehicle.

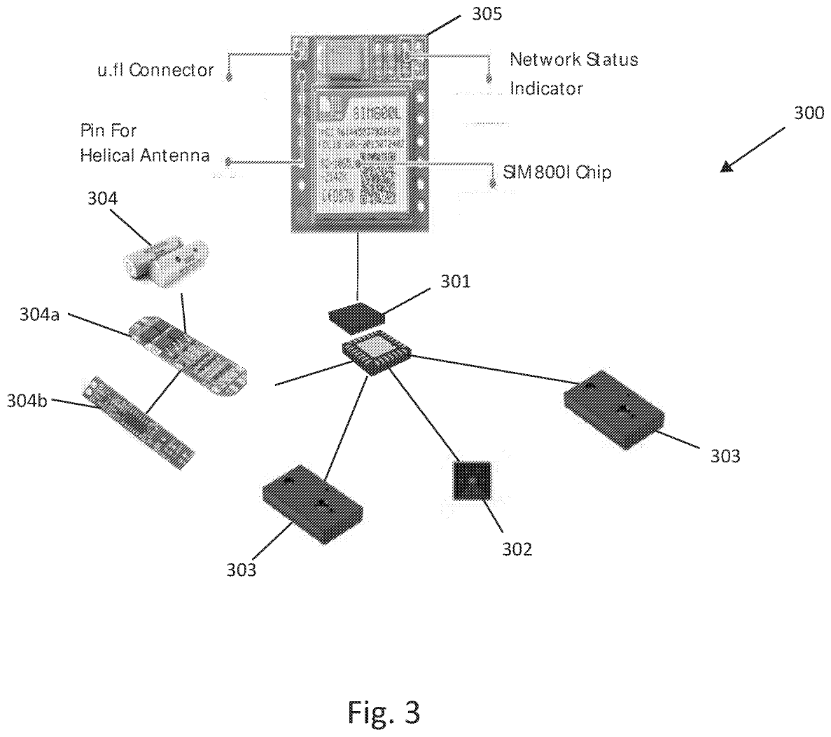

FIG. 3 schematically illustrates an exemplary configuration of the proposed system, according to an embodiment of the present invention, in which system 300 comprises a main controller 301, a camera module 302, TOF sensors 303, a rechargeable power storage 304 (e.g., standard lithium-ion batteries) with suitable charging management module 304a (i.e., which is connected to USB port 104 of FIG. 1), and a capacity level module 304b which indicates on battery level and alerts of battery fault. System 300 further comprises a communication module 305 capable of communicating wirelessly with one or more remote stations (e.g., GPRS module which enables communication with remote phones and internet connection).

According to an embodiment of the present invention, during a vehicle's travel battery 304 is being charged through the USB port 104 (of FIG. 1) and a standard adapter to the vehicular power supply (e.g., standard auxiliary 12 volts/24 volts of common vehicles), up to a capacity which allows an independent operating of system 300 (i.e., while the vehicle's power supply is off) for a limited period of time (e.g., 30 minutes, 1 hour, two hours, etc.) controlled by charging module 304a, where this operational mode of system 300 enables the use of lower capacity power source such as standard low-size lithium-ion batteries, which is essential for the compact design and easy handling of system 300.

One skilled in the art will identify the multiple possible configurations in which the connection to the vehicular 12 volts/24 volts power supply can be realized, with respect to the desired target seat (i.e., newborn and young babies may be seated in safety seats attached to either the front passenger seat or to one of the back seats, and accordingly system 300 may be installed onto the front windshield or to a suitable location of the vehicle's ceiling), where the corresponding power supply for charging system 300 may be a standard vehicular 12 v/24 v outlet, or a +12 v/+24 v supply wire to one of the passenger's cabin appliances (e.g., ceiling lighting).

According to some embodiments of the present invention, following the vehicle's parking and engine shut-off (i.e., charging management module 304a detects the power supply to USB port 104 is shut-off for a predetermined default time or per user's preference), controller 301 activates camera 102 (of FIG. 1) to monitor back seat 201 (of FIG. 2) while utilizing motion detection and faces recognition algorithms. Following the detection of motion and presence of one or more faces by camera 102, controller 301 activates TOF sensors 103a and 103b to monitor for the presence of an object within safety seat 202a or 202b.

One skilled in the art will readily realize alternate detection scripts, being enabled by the evolving technologies of detection measures such as TOF sensors 103a -103b and camera 102 in conjunction with suitable detection algorithms, without departing from the principles of the present invention. One example is where the proposed system is provided with TOF sensors 130a -103b that consume less battery power than camera 102 (of FIG. 1), following the vehicle's parking and engine shut-off (i.e., the power supply to USB port 104 is being shut-off as well), controller 301 activates TOF sensors 103a and 103b for monitoring back seat 201 (of FIG. 2) while utilizing motion detection and faces recognition algorithms (e.g., rapid distance variations may indicate on both the presence of an object/objects in safety seat 202a and/or 202b and motion thereof). Following detection of static or moving objects in seats 202a and/or 202b, controller 301 activates camera 102 (of FIG. 1) in conjunction with a face recognition algorithm to identify if a detected object is a child.

Whereas the combined detection of one or more child left in seats 202a and/or 202b, in a parking vehicle, controller 301 initiates an alerting mode (i.e., pre-configured by default or per user preferences), in which the proposed system initiates communication (i.e., by utilizing communication module 305) to a driver's phone and/or added contacts and emergency services.

While in a basic configuration the proposed system will utilize module 305 for transmitting a simple pre-configured text/voice alert message, according to some embodiments of the present invention, the proposed system may also be provided with 2-way communication sound and/or video means for communicating with a child left in the car and possibly guiding the child as required.

According to some embodiments of the present invention, additional sensors are integrated with the proposed system (e.g., temperature sensors measuring ambient temperature, infrared sensors for evaluating a child's heat, CO/CO2/NOx level sensors, GPS receiver, sound detection sensors, etc.) for providing further relevant information and for enabling further relevant alerting scenarios (e.g., sending the vehicle's location, earlier alerting to the driver and to the emergency services when the ambient/child temperatures are higher, alerting on respiratory distress danger in case a window is open and residing vehicles' combustion gases enters the monitored vehicle, baby cry detection, etc.).

As illustrated in the above figures and embodiments, the proposed system is external and independent to the vehicle seat or child safety seat, and hence, is applicable for multiple different existing vehicle configurations and does not require special modifications to the seats or to the vehicular systems.

Although embodiments of the invention have been described by way of illustration, it will be understood that the invention may be carried out with many variations, modifications, and adaptations, without exceeding the scope of the claims.

1. an intelligent vehicle seat monitoring and alerting system, comprising:
a. an enclosure;
b. a camera being adapted to detect motion and to recognize faces when being utilized in conjunction with suitable processing hardware and software;
c. at least one distance detection sensor being adapted to measure a distance to a target object, and to detect the presence of objects at a different distance than an initially taught reference distance, thereby being capable of detecting the presence of an object in a target vehicle seat, by utilizing said camera and said at least one distance detection sensor;
d. a controller being configured to control said camera and said at least one TOF sensor, thereby to alert a driver when detecting a child being left in a parking vehicle's seat;
e. a communication module capable of communicating wirelessly with one or more remote stations;
f. a rechargeable power storage of suitable capacity for providing sufficient electric power for the operation of said system;
g. a charging port being utilized as a power supply connection inlet being connected to a vehicular power supply; and
h. a charging management module being adapted to control the charging of said rechargeable power storage through said charging port, and to detect a vehicle's engine shut-off resulting with the power supply to said charging port being shut-off.

2. The system of claim 1, provided with attachment means of the enclosure to a vehicles' ceiling.

3. The system of claim 1, provided with attachment means of the enclosure to a vehicles' front windshield.

4. The system of claim 1, in which the power storage is a rechargeable battery.

5. The system of claim 1, provided with additional sensors being selected from the group consisting of: temperature sensors, infrared sensors, CO level sensors, CO₂ level sensors, NOx level sensors, GPS receiver, sound detection sensors, or any combination thereof.

6. The system of claim 1, further comprising a capacity level module being adapted to indicate the stored power level of the rechargeable power storage and to alert in case of power faults.

7. The system of claim 1, in which the charging port is a USB port.

8. The system of claim 1, in which the charging port is being utilized as a data connection for system configuration and software updates.

9. The system of claim 1, further comprising 2-way communication sound and/or video means for communicating with a child left in the car.

10. The system of claim 1, in which the at least one distance detection sensor is a TOF sensor.

11. The system of claim 1, in which the communication module is a GPRS module which enables communication with remote phones and an internet connection.
